(19) United States
(12) Patent Application Publication
(10) Pub. No.: US 2003/0110320 A1
(43) Pub. Date: Jun. 12, 2003

(54) Information processing apparatus

(76) Inventors: Takatsugu Ono, Kobe-shi (JP); Naoto Matsushita, Kobe-shi (JP); Toshikazu Nakahira, Kobe-shi (JP); Reiko Hiraoka, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/316,041

(22) Filed: Dec. 11, 2002

(30) Foreign Application Priority Data
Dec. 12, 2001 (JP) P2001-378398

(51) Int. Cl. G06F 3/00

(52) U.S. Cl. 710/1

(57) ABSTRACT

An object of the invention is to facilitate the convenience of users by making provisions so that the selection of data and an application program to be activated can be automatically made by just loading a recording medium. When a memory card is loaded into a receiving compartment of an automotive information processing apparatus, recorded information such as music or images is selected based on such data as a playback log, and played back in accordance with a predetermined ordering criterion, for example, in order of date/time of recording, date/time of use, frequency of use, etc. The application program used to play back the information is also activated automatically.

### BACKGROUND OF THE INVENTION

1. Field of the Invention

The present invention relates to an information processing apparatus in which a recording medium such as a memory card can be removably loaded.

2. Description of the Related Art

Data such as music and image data to be played back and data to be processed by various kinds of computer programs are often input to an information processing apparatus by being stored on a recording medium. Optical discs such as CD (Compact Disc) and DVD (Digital Versatile Disc) are commonly used as recording media for storing music, image, and like data. Optical discs of the type that allows users to write data thereon, such as CD-R, CD-RW, DVD-R, DVD-RW, and DVD-RAM, are also used. Memory cards using semiconductor memories, such as PCMCIA (Personal Computer Memory Card International Association) memory card, Memory Stick, and SD (Secure Digital) card, are also finding widespread use as their storage capacity increases and price drops, since these types of memory, unlike disk type recording media, do not require the use of drive units. When reproducing and processing information recorded on such a recording medium, the information is generally processed in the order of recording addresses on the recording medium.

To facilitate the convenience of users who use memory cards, Japanese Unexamined Patent Publication JP-A 6-309515 (1994), for example, discloses prior art in which an IC memory card is used as a storage medium for storing images, voice, characters, etc. and data and commands specifying the order of playback of the images, voice, etc., the number of playbacks, the playback time, etc. are stored in the form of a command file on the IC memory card. When the IC memory card is loaded, the images, etc. are played back in accordance with the command file. In conventional computers also, it is widely practiced to create commands in advance in the form of a batch file, script file, or macro file, and to reproduce and process information in accordance with the prescribed commands.

To facilitate the convenience of users who use recording media such as optical discs, Japanese Unexamined Patent Publication JP-A 6-103737 (1994), for example, discloses prior art in which audio data is played back in time sequence in accordance with date/time information in the TOC (Table Of Contents) area. In the prior art disclosed in Japanese Unexamined Patent Publication JP-A 10-243354 (1998), there is disclosed a playback or reverse playback function in which, when playing back a movie, data are sequentially transferred starting from the data most recently written to a buffer memory.

As for the sequence of processing for a plurality of pieces of information recorded on a recording medium, the prior art disclosed in Japanese Unexamined Patent Publication JP-A 2-139783 (1990) proposes the provision of a frequency play key for playing back music by selecting pieces of music in accordance with the frequency of playback, in addition to a play key for playing back pieces of music in the order they are recorded and a random play key for playing back pieces of music in random order. The applicant of the present invention discloses prior art in Japanese Unexamined Patent Publication JP-A 4-351777 (1992) in which the number of times each piece of music has been played back is stored for each optical disc and pieces of music having higher frequency of playback are played back preferentially. Japanese Unexamined Patent Publication JP-A 10-234002 (1998) discloses prior art that enables audio/video information recorded on a randomly accessible recording medium to be played back in the order of recording or in preprogrammed order.

If data of different recording formats are stored on the same recording medium, the user has to take the trouble of selecting or specifying the recording format. To spare the user from such trouble, Japanese Unexamined Patent Publication JP-A 11-213560 (1999) discloses prior art in which, when reading an optical card that can store data in a plurality of logical formats, the optical card is read first by using the same format as the previously read optical card and, if it cannot be read properly, then another format is tried to read it. In the prior art disclosed in Japanese Unexamined Patent Publication JP-A 10-49974 (1998), a playback history of optical discs that have been played back in the past is recorded in a nonvolatile memory or the like and, when the playback apparatus is turned on, the initial playback mode is set to match the same optical disc type and physical format that were used the last time or to the playback mode most frequently used. Japanese Unexamined Patent Publication JP-A 60-55581 (1985) discloses prior art in which, for each optical disc previously played back, the number of times each piece of music recorded thereon has been played back is stored in an automotive DAD playback apparatus and, when playing back the same optical disc next time, the pieces of music are played back in decreasing order of the number of playbacks. In the prior art disclosed in Japanese Unexamined Patent Publication JP-A 7-104773 (1995), information such as the music titles that have been selected by users in the past is stored on a recording medium used in karaoke equipment and, when displaying a menu of titles on the screen for selection by a user, the titles are displayed in decreasing order of the frequency of use.

Various methods are also proposed for the use of recording media. In the prior art disclosed in Japanese Unexamined Patent Publication JP-A 2000-195234 (2000), information to be played back is randomly selected from a recording medium with a plurality of pieces of information recorded thereon, thereby attempting to achieve a playback operation that amuses the user. In the prior art disclosed in Japanese Unexamined Patent Publication JP-A 10-3778 (1998), when continuously playing back information recorded on an MD (Mini Disc), any piece of information can be excluded from the information to be played back without actually erasing the information and, when needed, the excluded information can be restored to the information to be played back. In the prior art disclosed in Japanese Unexamined Patent Publication JP-A 11-7700 (1999), a trash bin folder that allows data to be erased and then restored as needed is provided by utilizing the characteristic of a CD-R, a write once optical disc, that erasure is done only on the management data. In the prior art disclosed in Japanese Unexamined Patent Publication JP-A 7-192436 (1995), alterations to the UTOC that manages information on the MD are not done until the MD is removed, thereby enabling any editing operation involving alterations to the UTOC to be canceled before the MD is removed.

In connection with karaoke equipment, Japanese Unexamined Patent Publication JP-A 8-31150 (1996) discloses the idea that the method used to process information recorded on a recording medium is stored as history data on a history card and, when processing the information next time, the history data stored on the history card is read out so that the user can easily select the recently processed information or frequently processed information. The applicant of the present invention discloses prior art in Japanese Unexamined Patent Publication JP-A 10-166956 (1998) in which the settings for operation of an automotive audio apparatus, etc. are made in connection with an ID code used in an automotive keyless entry system.

Japanese Unexamined Patent Publication JP-A 9-128879 (1997) discloses prior art in which, in an apparatus capable of playing back recording media of different recording formats, such as audio CD, video CD, photo CD, etc., an identification program for the most recently used recording format is preferentially executed and, after that, identification programs are executed in order of frequency of use. Japanese Unexamined Patent Publication JP-A 2000-20288 (2000) discloses prior art in which, when a personal computer or the like is turned on with a recording medium such as a CD-ROM loaded therein, if a bootable program is recorded on the recording medium, the program is executed, and if data is recorded in a form ready for playback, a program for playing back the data is activated.

Usually, in an audio apparatus for playing back only audio CDs or MDs, when a recording medium is loaded, the recorded music is automatically played back in the order of recording, as earlier described. When a random mode is specified, the music is played back in programmed order or random order. There is also proposed a design in which playback history for each recording medium is managed in the apparatus so that frequently played back music or most recently played back music can be preferentially selected.

In recent years, the recording capacity of recording media such as optical discs has been increasing, increasing the amount of information that can be recorded thereon. Further, for automotive and like apparatuses, since the installation space is limited, it has become possible to achieve multiple functions, such as audio playback, video playback, and navigation, with a single apparatus. In the case of optical discs, the CD and the DVD is identical in physical shape. Further, various kinds of information, such as voice, images, data, and programs, can be recorded on these discs, and recording media of the type that allows the user to record information thereon are also finding widespread use.

When using a memory card as the recording medium, a list of recorded contents of the card is displayed when the card is loaded in an information processing apparatus. The user then selects the information to be processed and the application program to be used for processing the information, after which the processing by the selected application program is initiated. Accordingly, the recorded information cannot be played back by just loading the memory card, and the user has to take the trouble of selecting the application program that matches the information.

### SUMMARY OF THE INVENTION

An object of the present invention is to provide an information processing apparatus capable of facilitating the convenience of users by making provisions so that the selection of data and an application program to be activated can be automatically made by just loading a recording medium.

The invention provides an information processing apparatus in which a plurality of information processing programs can be operated and a recording format of information to be processed by program operation is predetermined for each of the information processing programs, the apparatus comprising:

medium loading means for removably receiving an information recording medium capable of recording a plurality of pieces of information, the medium loading means being adapted to be able to read out the information recorded on the information recording medium when the information recording medium is loaded therein;

control means for performing control so that, upon loading of the information recording medium to the medium loading means, a first piece of information recorded on the information recording medium is read out in accordance with a predetermined ordering criterion, an information processing program that matches the recording format of the first piece of information is selectively activated to process the first piece of information and, when reading out second and subsequent pieces of information from the information recording medium, the information recorded in the recording format that can be processed by the information processing program is sequentially read out in accordance with the ordering criterion; and

storage means which stores data for reading out the information from the information recording medium in accordance with the ordering criterion.

According to the information processing apparatus of the invention, an information recording medium capable of recording a plurality of pieces of information can be removably loaded into the medium loading means and, when the information recording medium is loaded, the information recorded on the information recording medium can be read out. The information recording medium can record thereon a plurality of pieces of information in different recording formats. Upon detecting the loading of the information recording medium to the medium loading means, the control means performs control so that the first piece of information recorded on the information recording medium is read out in accordance with the predetermined ordering criterion, and so that the information processing program that matches the recording format of the information is selectively activated to process the information. When reading out the second and subsequent pieces of information from the information recording medium, control is performed so that the information recorded in the recording format that can be processed by the information processing program is sequentially read out in accordance with the ordering criterion. Since the data for reading out the information from the information recording medium in accordance with the ordering criterion is stored in the storage means, the information readout from the information recording medium can be performed automatically, and since the information processing program for processing the a a first piece of information is selected based on the first piece of information, the user can have the recorded information processed automatically by just loading the information recording medium into the medium loading means.

According to this invention, when the user loads the information recording medium, the first piece of information recorded on the information recording medium is read out in accordance with the predetermined ordering criterion, and the information processing program that matches the recording format of the information is selectively activated so that the information can be processed. By just loading the information recording medium, the user can have the readout and processing of the information performed automatically. When reading out the second and subsequent pieces of information from the information recording medium, since the information recorded in the recording format that can be processed by the activated program is sequentially read out in accordance with the ordering criterion, the information can be processed sequentially by using the same information processing program.

In the invention it is preferable that data concerning date/time of recording of the information is stored in the storage means, and

the control means performs control so that the information most recently recorded on the information recording medium is read out as the first piece of information by using the date/time of information recording on the information recording medium as the ordering criterion, and the control means activates the information processing program that matches the recording format of the information.

According to this invention, when the user loads the information recording medium into the medium loading means, since the information recorded on the information recording medium is sequentially presented for processing in descending order of the date/time of recording, the most recently recorded information can be preferentially selected for processing.

In the invention it is preferable that data concerning date/time the information was used for processing is stored in the storage means, and

the control means performs control so that the information most recently used in the information recording medium is read out as the first piece of information by using as the ordering criterion the date/time the information recorded on the information recording medium was last used, and the control means activates the information processing program that matches the recording format of the information.

According to this invention, when the user loads the information recording medium into the medium loading means, since the information recorded on the information recording medium is sequentially presented for processing in descending order of the date/time of use, the most recently used information can be preferentially selected for processing.

In the invention it is preferable that data concerning the number of times the information has been used for processing is stored in the storage means, and

the control means performs control so that the information most frequently used in the information recording medium is read out as the first piece of information by using as the ordering criterion the number of times the information recorded on the information recording medium has been used, and the control means activates the information processing program that matches the recording format of the information.

According to this invention, when the user loads the information recording medium into the medium loading means, since the information recorded on the information recording medium is sequentially presented for processing in descending order of the frequency of use, the most frequently used information can be preferentially selected for processing.

In the invention it is preferable that data concerning the number of times the information has been used for processing is stored in the storage means, and

the control means performs control so that the total number of times the information recorded on the information recording medium has been used is calculated for each recording format and, by using the total number of times as the ordering criterion, the information selected in accordance with a predetermined criterion is read out as the first piece of information from among the information of the most frequently used recording format in the information recording medium, and the control means activates the information processing program that matches the recording format of the information.

According to this invention, when the user loads the information recording medium into the medium loading means, since the information recorded on the information recording medium in the most frequently used recording format is sequentially presented for processing in accordance with the predetermined criterion, the information of the most frequently used recording format can be preferentially selected for processing.

In the invention it is preferable that the predetermined criterion is the date/time of recording.

According to this invention, when the user loads the information recording medium into the medium loading means, since the information recorded on the information recording medium in the most frequently used recording format is sequentially presented for processing in descending order of the date/time of recording, the information most recently recorded in the most frequently used recording format can be preferentially selected for processing.

In the invention it is preferable that information of a particular recording format that can be processed by any one of a plurality of information processing programs is recorded on the information recording medium,

the information processing apparatus further includes other storage means for storing the number of times each of the information processing programs that can process the information of the particular recording format has been used for processing the information, and

the control means performs control so that, when the information read out as the first piece of information from the information recording medium is the information of the particular recording format that can be processed by any one of the plurality of information processing programs, the most frequently used information processing program is activated based on the number of times stored in the other storage means.

According to this invention, when the user loads the information recording medium into the medium loading means, the information processing program most frequently used for processing the information of the particular recording format is activated by preferentially selecting it from among the plurality of information processing programs that match the recording format of the information.

In the invention it is preferable that data concerning date/time of recording of the information and, of the plurality of information processing programs, the information processing program last used for the processing of the information, are stored in the storage means, and

the control means performs control so that the information most recently recorded on the information recording medium is read out as the first piece of information from among the information of the recording format that can be processed by the information processing program recorded in the storage means and, when reading out the second and subsequent pieces of information, the information recorded in that recording format is sequentially read out in order of date/time of recording.

According to this invention, when the user loads the information recording medium into the medium loading means, the information most recently recorded on the information recording medium is read out as the first piece of information, and after activating the information processing program that matches the recording format of the information, the second and subsequent pieces of information recorded in that recording format is processed in order of date/time of recording, so that the information can be sequentially processed by using the same information processing program.

In the invention it is preferable that data concerning date/time the information was used for processing and, of the plurality of information processing programs, the information processing program last used for the processing of the information, are stored in the storage means, and

the control means performs control so that the information most recently used in the information recording medium is read out as the first piece of information from among the information of the recording format that can be processed by the information processing program stored in the storage means and, when reading out the second and subsequent pieces of information, the information recorded in that recording format is sequentially read out in order of date/time of use.

According to this invention, when the user loads the information recording medium into the medium loading means, the information most recently used in the information recording medium is read out as the first piece of information, and after activating the information processing program that matches the recording format of the information, the second and subsequent pieces of information recorded in that recording format is processed in order of date/time of use, so that the information can be sequentially processed by using the same information processing program.

In the invention it is preferable that data concerning date/time of recording of the information and the number of times each of the plurality of information processing programs has been used for the processing of the information are stored in the storage means, and

the control means performs control so that the information most recently recorded on the information recording medium is read out as the first piece of information from among the information of the recording format that can be processed by the most frequently used information processing program stored in the storage means and, when reading out the second and subsequent pieces of information, the information recorded in that recording format is sequentially read out in order of date/time of recording.

According to this invention, when the user loads the information recording medium into the medium loading means, the most frequently used information processing program is activated by selecting it from among the information processing programs that match the recording format of the information stored on the information recording medium, the information most recently recorded on the information recording medium is read out as the first piece of information from among the information recorded in that recording format, and the second and subsequent pieces of information recorded in that recording format is processed in order of date/time of recording, so that the information can be sequentially processed by using the same information processing program.

In the invention it is preferable that data concerning date/time the information was used for processing and the number of times each of the plurality of information processing programs has been used for the processing of the information are stored in the storage means, and

the control means performs control so that the information most recently used in the information recording medium is read out as the first piece of information from among the information of the recording format that can be processed by the most frequently used information processing program stored in the storage means and, when reading out the second and subsequent pieces of information, the information recorded in that recording format is sequentially read out in order of date/time of use.

According to this invention, when the user loads the information recording medium into the medium loading means, the most frequently used information processing program is activated by selecting it from among the information processing programs that match the recording format of the information stored on the information recording medium, the information most recently used in the information recording medium is read out as the first piece of information from among the information recorded in that recording format, and the second and subsequent pieces of information recorded in that recording format is processed in order of date/time of use, so that the information can be sequentially processed by using the same information processing program.

In the invention it is preferable that data concerning date/time the information was used for processing is stored in the storage means, and

the control means performs control so that, among the information of the recording format most predominantly used for the information recorded on the information recording medium, the information most recently used in the information recording medium is read out as the first piece of information and, when reading out the second and subsequent pieces of information, the information recorded in that recording format is sequentially read out in order of date/time of use.

According to this invention, when the user loads the information recording medium into the medium loading means, among the information of the recording format most predominantly used for the information recorded on the information recording medium, the most recently used information is read out as the first piece of information from the information recording medium, after which the second and subsequent pieces of information recorded in that recording format can be processed sequentially in order of date/time of use.

According to this invention, when the user loads the information recording medium, an information processing program is activated that matches the recording format most predominantly used for the information recorded on the information recording medium, and the information recorded in that recording format can be processed sequentially in order of date/time of use.

In the invention it is preferable that data concerning date/time of recording of the information is stored in the storage means, and

the control means performs control to search the kinds of the recording formats of the information recorded on the information recording medium, select a particular recording format at random from among the kinds of the recording formats, and read out the most recently recorded information as the first piece of information from among the information recorded in that recording format, and when reading out the second and subsequent pieces of information, the information recorded in that recording format is sequentially read out in order of date/time of recording.

According to this invention, when the user loads the information recording medium into the medium loading means, among the information of the recording format selected at random from among the recording formats of the information recorded on the information recording medium, the information most recently recorded on the information recording medium is read out as the first piece of information, after which the second and subsequent pieces of information recorded in that recording format can be processed sequentially in order of date/time of recording.

In the invention it is preferable that data concerning date/time the information was used for processing is stored in the storage means, and

the control means performs control to search the kinds of the recording formats of the information recorded on the information recording medium, select a particular recording format at random from among the kinds of the recording formats, and read out the most recently used information as the first piece of information from among the information recorded in that recording format, and when reading out the second and subsequent pieces of information, the information recorded in that recording format is sequentially read out in order of date/time of use.

According to this invention, when the user loads the information recording medium into the medium loading means, among the information of the recording format selected at random from among the recording formats of the information recorded on the information recording medium, the most recently used information is read out as the first piece of information from the information recording medium, after which the second and subsequent pieces of information recorded in that recording format can be processed sequentially in order of date/time of use.

The invention also provides an information processing apparatus in which a plurality of information processing programs can be operated and a recording format of information to be processed by program operation is predetermined for each of the information processing programs, the apparatus comprising:

medium loading means for removably receiving an information recording medium capable of recording a plurality of pieces of information, the medium loading means being adapted to be able to read out the information recorded on the information recording medium when the information recording medium is loaded therein;

candidate presenting means which, upon detecting the loading of the information recording medium to the medium loading means, searches the kinds of the recording formats of the information recorded on the loaded information recording medium and, of the plurality of information processing programs, presents as candidates the information processing programs that can process the information of the thus searched recording formats;

operation input means for accepting an input operation for selecting one of the candidates presented by the candidate presenting means; and

control means for activating the information processing program selected from among the candidates in response to the input operation performed on the operation input means, and for performing control so that the information recorded on the information recording medium is sequentially read out in accordance with a predetermined ordering criterion from among the information of the recording format to be processed by the selected information processing program.

According to the information processing apparatus of this invention, an information recording medium capable of recording a plurality of pieces of information can be removably loaded into the medium loading means and, when the information recording medium is loaded, the information recorded on the information recording medium can be read out. The information recording medium can record thereon a plurality of pieces of information in different recording formats. The candidate presenting means searches the kinds of the recording formats of the information recorded on the loaded information recording medium and, of the plurality of information processing programs, presents as candidates the information processing programs that can process the information of the thus searched recording formats. The user can select one of the candidates by operating the operation input means. The control means activates the information processing program selected by the user from among the candidates, and performs control so that the information recorded on the information recording medium is sequentially read out in accordance with the predetermined ordering criterion from among the information of the recording format to be processed by the selected information processing program; this facilitates the activation of the information processing program suitable for reading the information from the information recording medium.

In the invention it is preferable that the information recording medium is a memory card, and

the storage means is provided within the information recording medium.

According to this invention, by just loading the memory card, the information processing program that matches the recorded information can be automatically activated to process the information.

In the invention it is preferable that the medium loading means is provided with more than one receiving compartment for receiving the information recording medium, and

an information processing program for processing the information can be prespecified for each receiving compartment.

According to this invention, when the user selects the receiving compartment into which the memory card is to be loaded, the information processing program for processing the recorded information is automatically specified, thus simplifying the process of specifying the information processing program.

Further, according to this invention, since the information processing program to be activated when the memory card is loaded is prespecified for each memory card receiving compartment, the information processing program for processing the recorded information can be easily specified by just selecting the receiving compartment.

The invention also provides a program for causing a computer to function as either one of the information processing apparatuses described above.

The invention provides a computer readable recording medium on which a program is recorded which causes a computer to implement the steps of:

in response to loading an information recording medium capable of recording a plurality of pieces of information to medium loading means for removably receiving the information recording medium, retrieving a plurality of pieces of information recorded in the information recording medium and data for reading out the plurality of pieces of information in accordance with a predetermined ordering criterion stored in storage means;

reading out the data from the storage means;

reading out a first piece of information recorded on the information recording medium, in accordance with the predetermined ordering criterion;

selectively activating an information processing program that matches a recording format of the first piece of information, out of a plurality of information processing programs, and processing the first piece of information; and

reading out second and subsequent pieces of information recorded in a recording format that can be processed by the information processing program, in accordance with the ordering criterion, and processing the second and subsequent pieces of information.

The invention provides a computer readable recording medium on which a program is recorded which causes a computer to implement the steps of:

in response to loading an information recording medium capable of recording a plurality of pieces of information to medium loading means for removably receiving the information recording medium, retrieving a recording format of information recorded in the information recording medium loaded to the medium loading means;

presenting as candidates information processing programs that can process information of thus retrieved recording format, out of a plurality of information processing programs;

in response to an operation of selection from among the presented candidates by a user, activating an information processing program selected; and

sequentially reading out the information recorded on the information recording medium in accordance with a predetermined ordering criterion from among the information of the recording format to be processed by the selected information processing program.

According to this invention, when the information recording medium is loaded into the computer for processing the information, the information processing program that matches the recording format of the information recorded on the information recording medium is activated so that the information highly likely to be the information the user wants to be processed can be automatically processed.

### BRIEF DESCRIPTION OF THE INVENTION

Other and further objects, features, and advantages of the invention will be more explicit from the following detailed description taken with reference to the drawings wherein:

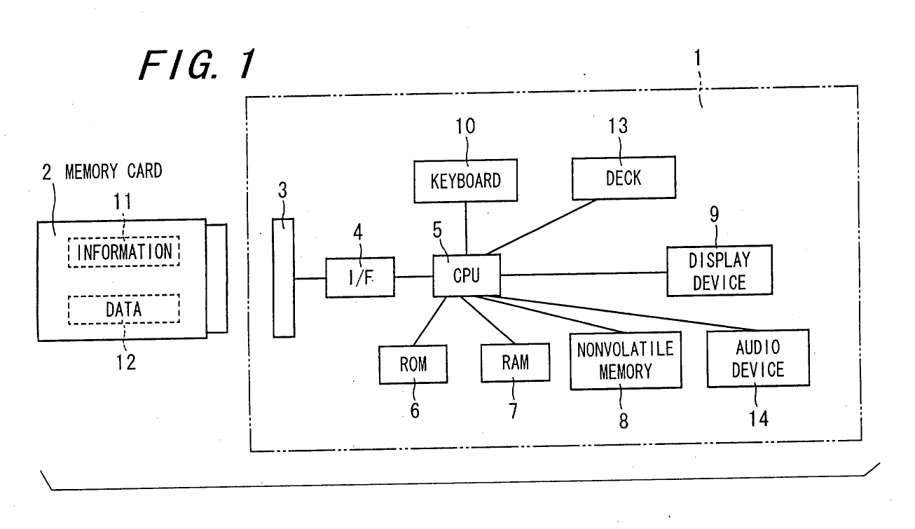

FIG. 1 is a block diagram showing in simplified form the system configuration of an automotive information processing apparatus according to one embodiment of the present invention.

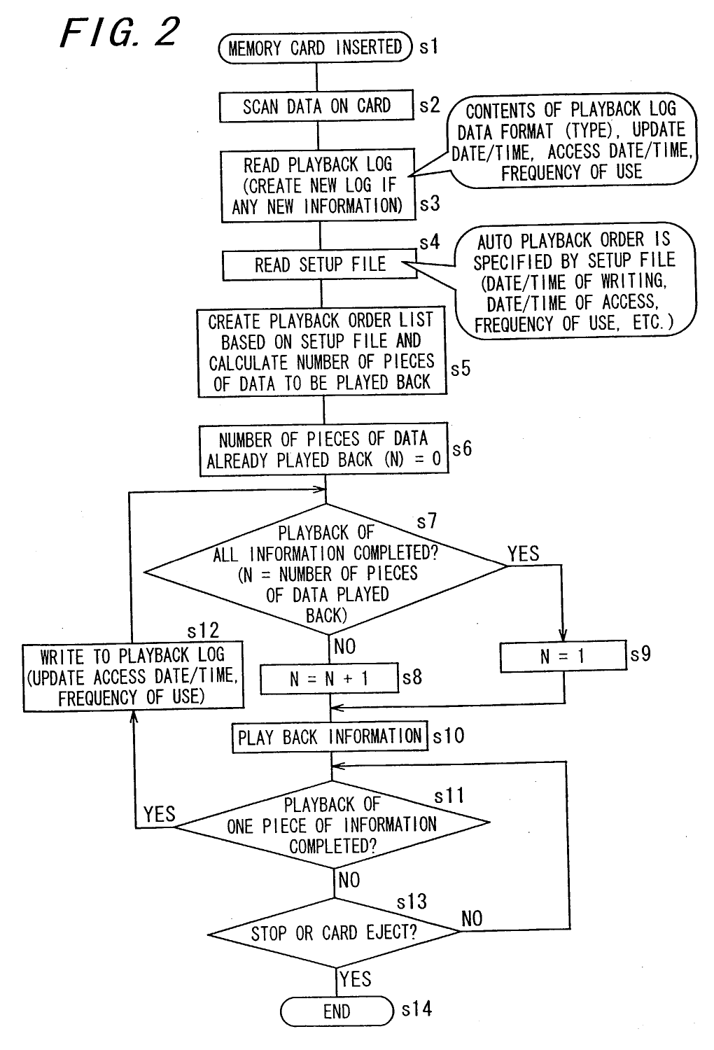

FIG. 2 is a flow chart illustrating a control procedure for auto playback which is initiated when a memory card is loaded into the automotive information processing apparatus of FIG. 1.

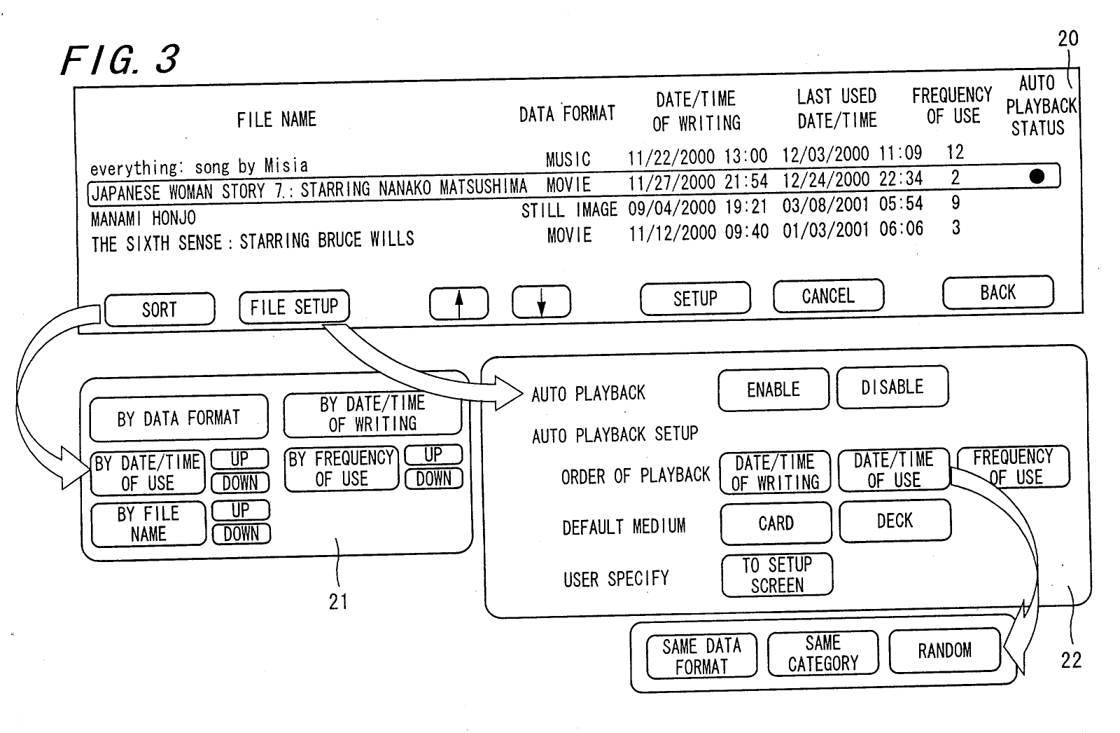

FIG. 3 is a diagram showing a screen for setting auto playback functions in accordance with the embodiment of FIG. 1.

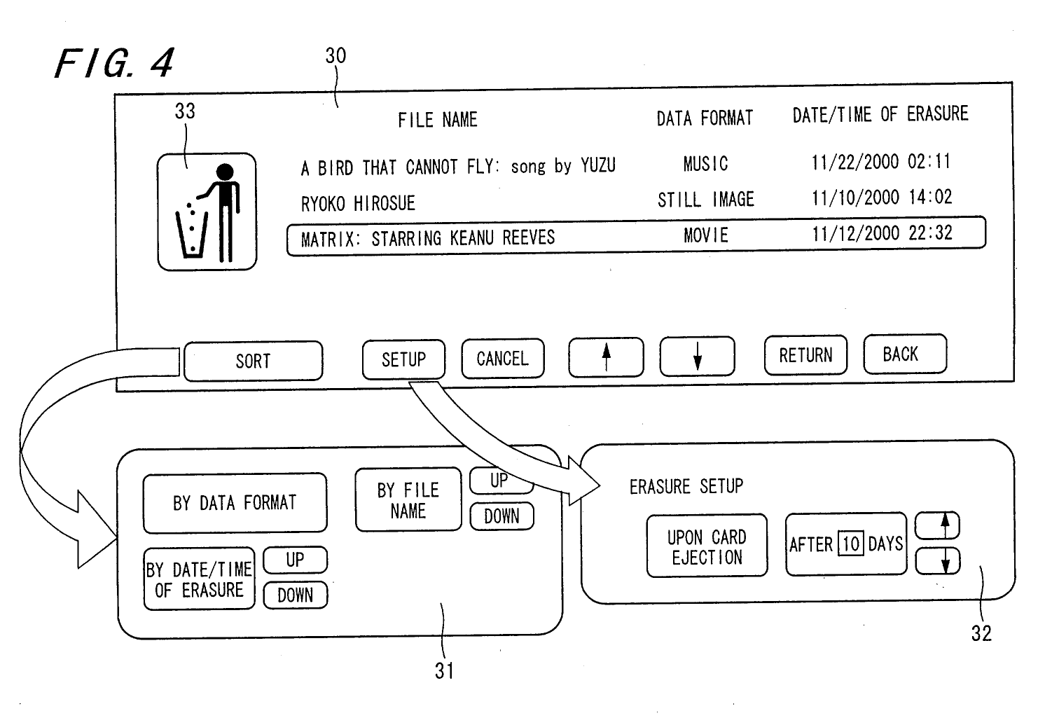

FIG. 4 is a diagram showing a screen for information erasure in accordance with another embodiment of the present invention.

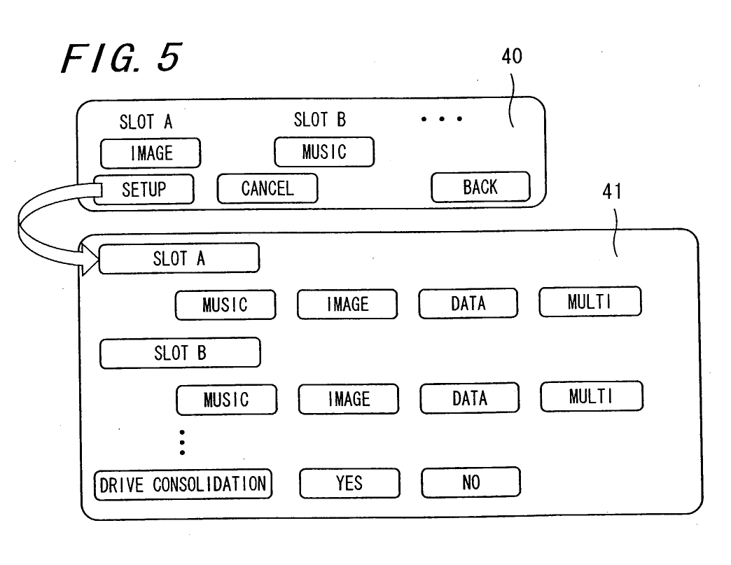

FIG. 5 is a diagram showing a screen for specifying functions for each of a plurality of receiving compartments for the memory card in accordance with still another embodiment of the present invention.

### DETAILED DESCRIPTION OF THE PREFERRED EMBODIMENTS

Now referring to the drawings, preferred embodiments of the invention are described below.

FIG. 1 shows in simplified form the system configuration of an automotive information processing apparatus 1 according to one embodiment of the present invention. In the automotive information processing apparatus 1, a plurality of application programs can be operated and the recording format of information to be processed by program operation is predetermined for each application program. A memory card 2 as an information recording medium capable of recording a plurality of pieces of information can be removably loaded into a receiving compartment 3, and the recorded information can be read out when the memory card 2 is loaded. The readout information is input from the receiving compartment 3 to a CPU 5 via an interface circuit (hereinafter abbreviated as I/F) 4. When the memory card 2 is loaded into the receiving compartment 3 which is a medium loading means connected to the I/F 4, the CPU 5 as a control means reads out a first piece of information from the memory card 2 in accordance with a predetermined ordering criterion, and processes the information by selectively activating an application program that matches the recording format of the first piece of information. The plurality of application programs and a program for activating the application programs are prestored in a ROM 6. When the CPU 5 executes each program, a RAM 7 is used as a work memory. The operation history of each application program is stored in a recordable nonvolatile memory 8 such as a flash memory.

The information recorded on the memory card 2 includes image information such as movies and still images, and the recorded images can be displayed on a display device 9. Recording formats such as MPEG and video CD or formats such as QuickTime, a trademark of Apple Computer, are used for the recording of movies. Still images are recorded using such formats as BMP, JPEG, or photo CD. Application programs capable of playing back information of one particular recording format or a plurality of recording formats are stored in the ROM.

In the present embodiment, the operation mode to be activated when the memory card 2 is loaded into the receiving compartment 3 can be preset by the user via a keyboard 10 which is an operation input means. The operation modes that can be preset include an auto playback mode; when setting the operation mode to the auto playback mode, an ordering criterion for defining the order of playback can be preset. The memory card 2 is capable of recording information 11 to be processed by an application program for playback, etc. and data 12 which is referenced based on the ordering criterion for auto playback.

The automotive information processing apparatus 1 is also equipped with a deck 13 into which a recording medium different from the memory card 2 such as optical discs, etc. can be removably loaded, and which can read the recorded contents when the recording medium is loaded. When a DVD, a CD-ROM, or a video CD is loaded into the deck 13, image data or map data for navigation can be read out for display on the display device 9. In the receiving compartment of the memory card 2 and the deck 13, audio information such as music recorded in various recording formats can be read out, and can be reproduced as sound by means of an audio device 14. There are also cases where both video and audio information are reproduced.

FIG. 2 shows a control procedure which is initiated when the memory card 2 is loaded into the receiving compartment 3 according to the embodiment of FIG. 1. When the memory card 2 is loaded into the receiving compartment 3 in step s1, the I/F 4 notifies the CPU 5 by causing, for example, an interrupt. In step s2, the CPU 5 performs a data scan to search the information 11 and data 12 stored on the memory card 2. The data 12 includes a playback log for recording the data format (type), update date/time, access date/time, frequency of use, etc. for each piece of information 11. In step s3, the playback log is read out and, if there is any new piece of information 11, a new log is created. In step s4, a setup file for specifying the auto playback order is read out. The setup file is identified by a specific file name, and can specify the auto playback order to play back the information in order of date/time of writing, date/time of access, frequency of use, etc. In step s5, a playback order list for the information 11 is created based on the setup file, and the number of pieces of data to be played back, i.e., the number of pieces of information 11 to be played back, is calculated.

Next, in step s6, a parameter N representing the number of pieces of data already played back is initialized to 0. In step s7, it is determined whether the value of N is equal to the number of pieces of data played back, that is, whether the playback of all the data pieces is completed. If it is determined that the playback is not completed yet, the value of N is incremented by 1 in step s8. If it is determined in step s7 that the playback of all the data pieces is completed, the value of N is re-set to 1 in step s9. After step s8 or s9, the process proceeds to step s10 to play back the information 11. In step s11, it is determined whether the playback of one piece of information 11 is completed. If it is determined that the playback is completed, then in step s12 the access date/time, frequency of use, etc. are updated and written to the playback log in the data 12, and the process returns to s7. If it is determined in step s11 that the playback of one piece of information 11 is not completed yet, then it is determined in step s13 whether a playback stop or card eject operation has been performed. If it is determined that neither the playback stop nor the card eject operation has been performed, the process returns to step s11. If it is determined in step s13 that the playback stop or card eject operation has been performed, the procedure is terminated in step s14.

As described above, in the present embodiment, the memory card 2 capable of recording a plurality of pieces of information 11 can be removably loaded into the receiving compartment 3, and the information 11 recorded on the memory card 2 can be read out when the memory card 2 is loaded. The memory card 2 can record thereon a plurality of pieces of information in different data formats. Upon detecting the loading of the memory card 2 to the receiving compartment 3, the CPU 5 performs control so that the first piece of information recorded on the memory card 2 is read out in accordance with the predetermined ordering criterion defined in the setup file, and so that the application program that matches the data format of the information is selectively activated to process the information 11. When reading out the second and subsequent pieces of information 11 from the memory card 2, control is performed so that the information 11 recorded in the data format that can be processed by the application program is sequentially read out in accordance with the ordering criterion. Since the data 12 for reading out the information from the memory card 2 in accordance with the ordering criterion is stored in the memory card 2 itself, the readout of the information 11 from the memory card 2 can be performed automatically, and since the application program for processing the first piece of information 11 is selected based on the first piece of information 11, the user can have the recorded information 11 processed automatically by just loading the memory card 2 into the receiving compartment 3.

FIG. 3 shows a screen displayed on the display device 9 of FIG. 1, showing the information 11 and data 12 recorded on the memory card 2 and illustrating how various settings are made. An information browse screen 20 displays a list of the recorded information 11 and the data 12 related to the information 11. The user can rearrange the display of listing by selecting “SORT” and setting the ordering criterion. From a sort screen 21, the user can select the ordering criterion from among “BY DATA FORMAT”, “BY DATE/TIME OF WRITING”, “BY DATE/TIME OF USE”, “BY FREQUENCY OF USE”, and “BY FILE NAME”. For “BY DATE/TIME OF USE”, “BY FREQUENCY OF USE”, and “BY FILE NAME”, the user can select “UP” to sort the list in ascending order or “DOWN” to sort it in descending order.

From the information browse screen 20, the user can select “FILE SETUP” to move to a setup screen 22. On the setup screen 22, the user can “ENABLE” or “DISABLE” auto playback. When the auto playback is enabled, the user can select the order of playback from among “IN ORDER OF DATE/TIME OF WRITING”, “IN ORDER OF DATE/TIME OF USE”, and “IN ORDER OF FREQUENCY OF USE”. The user can also select the default medium between “CARD” and “DECK”. When “IN ORDER OF DATE/TIME OF USE” is selected for the order of playback, the user can further select “SAME DATA FORMAT”, “SAME CATEGORY”, or “RANDOM”.

That is, in the automotive information processing apparatus 1 of the present embodiment, data concerning the date/time of recording of the information 11 is stored in the data 12 on the memory card 2, and settings can be made so that the CPU 5 performs control to read out the most recently recorded information 11 as the first piece of information from the memory card 2 by using as the ordering criterion the date/time of information 11 recorded on the memory card 2, and to activate the application program that matches the data format of the first piece of information. When the user loads the memory card 2 into the receiving compartment 3, since the information 11 recorded on the memory card 2 is sequentially presented for processing in descending order of date/time of recording, the last processed information 11 can be preferentially selected for processing.

Further, in the present embodiment, data concerning the date/time the information 11 was used for processing is stored in the data 12 on the memory card 2 and, in this case, settings can be made so that the CPU 5 performs control to read out the most recently used information 11 as the first piece of information from the memory card 2 by using as the ordering criterion the date/time of use of the information 11 recorded on the memory card 2, and to activate the application program that matches the data format of the first piece of information. When the user loads the memory card 2 into the receiving compartment 3, since the information 11 recorded on the memory card 2 is sequentially presented for processing in descending order of date/time of use, the most recently used information 11 can be preferentially selected for processing. Here, to enable new data 12 to be written to the memory card 2, a memory similar to the nonvolatile memory 8 should be provided in the memory card 2. The storage capacity required of such a memory can be made smaller than the recording capacity required for the information 11.

Further, in the present embodiment, data concerning the number of times the information 11 has been used for processing is stored in the data 12 on the memory card 2, and in this case, settings can be made so that the CPU 5 performs control to read out the most frequently used information 11 as the first piece of information from the memory card 2 by using as the ordering criterion the number of times the information 11 recorded on the memory card 2 has been used, and to activate the application program that matches the data format of the first piece of information. When the user loads the memory card 2 into the receiving compartment 3, since the information 11 recorded on the memory card 2 is sequentially presented for processing in descending order of frequency of use, the most frequently used information 11 can be preferentially selected for processing.

Further, in the present embodiment, data concerning the number of times the information 11 has been used for processing is stored in the data 12 on the memory card 2 and, in this case, settings can be made so that the CPU 5 performs control to: calculate for each data format the total number of times the information 11 recorded on the memory card 2 has been used; read out information, selected based on a predetermined criterion from among the information 11 of the most frequently used data format, as the first piece of information from the memory card 2 in accordance with the preset ordering criterion; and activate the application program that matches the data format of the first piece of information. When the user loads the memory card 2 into the receiving compartment 3, since the information 11 recorded on the memory card 2 is sequentially presented for processing in accordance with the predetermined criterion from among the information 11 of the most frequently used data format, the information 11 of the most frequently used data format can be preferentially selected for processing.

Here, the date/time of recording can be used as the predetermined criterion. In this case, since the information 11 recorded on the memory card 2 is sequentially presented for processing in descending order of date/time of recording from among the information 11 of the most frequently used data format, the most recently recorded information 11 of the most frequently used data format can be preferentially selected for processing.

Information 11 of the data format that can be processed by any one of a plurality of application programs is also recorded on the memory card 2, and the nonvolatile memory 8 or the like is provided as a storage means for recording the number of times each of the application programs has been used for processing the information 11 of that data format. When the information 11 read out as the first piece of information from the memory card 2 is of the data format that can be processed by any one of the plurality of application programs, the CPU 5 performs control to activate the most frequently used application program based on the frequency-of-use data stored in the storage means such as the nonvolatile memory 8. Here, settings can be made so that, when the user loads the memory card 2 into the receiving compartment 3, the information 11 read out as the first piece of information is processed by preferentially activating the most frequency used application program among the plurality of application programs that match the data format of that information.

Further, in the present embodiment, data concerning the date/time of recording of the information 11 is stored in the data 12 on the memory card 2 and, of the plurality of application programs, the application program last used for the processing of the information 11 is stored in the nonvolatile memory 8; in this case, settings can be made so that the CPU 5 reads out as the first piece of information the information 11 most recently recorded on the memory card 2 from among the information 11 of the data format that can be processed by the application program stored in the nonvolatile memory 8. When reading the second and subsequent pieces of information 11, the information 11 recorded in the same data format is read out in sequence in order of date/time of recording. When the user loads the memory card 2 into the receiving compartment 3, the information 11 most recently recorded on the memory card 2 is read out as the first piece of information, and the application program that matches the data format of the information 11 is activated and, thereafter, the second and subsequent pieces of information 11 recorded in that data format is processed in order of date/time of recording, so that the information 11 can be processed sequentially by using the same application program.

Further, data concerning the date/time the information 11 was used for processing is stored in the data 12 on the memory card 2. Of the plurality of application programs, the application program last used for the processing of the information 11 is stored in the nonvolatile memory 8; in this case, settings can be made so that the CPU 5 performs control to read out as the first piece of information the information 11 most recently used in the memory card 2 from among the information 11 of the data format that can be processed by the application program stored in the nonvolatile memory 8 and, when reading the second and subsequent pieces of information 11, the information 11 recorded in the same data format is sequentially read out in order of date/time of use. When the user loads the memory card 2 into the receiving compartment 3, the most recently used information 11 is read out as the first piece of information from the memory card 2, and the application program that matches the data format of the information 11 is activated and, thereafter, the second and subsequent pieces of information 11 recorded in that data format is processed in order of date/time of use, so that the information 11 can be processed sequentially by using the same application program.

Further, data concerning the date/time of recording of the information 11 is stored in the data 12 on the memory card 2, and the number of times each of the plurality of application programs has been used for processing the information 11 is stored in the nonvolatile memory 8; in this case, settings can be made so that the CPU 5 performs control to read out as the first piece of information the information 11 most recently recorded on the memory card 2 from among the information 11 of the data format that can be processed by the most frequently used application program selected based on the frequency-of-use data stored in the nonvolatile memory 8 and, when reading the second and subsequent pieces of information 11, the information 11 recorded in that data format is sequentially read out in order of date/time of recording. When the user loads the memory card 2 into the receiving compartment 3, the most frequently used application program is activated by selecting it from among the plurality of application programs that match the data format of the information 11 stored on the memory card 2 and, among the information 11 recorded in that data format, the information 11 most recently recorded on the memory card 2 is read out as the first piece of information, and the second and subsequent pieces of information 11 recorded in that data format is processed in order of date/time of recording, so that the information can be processed sequentially by using the same application program.

Further, data concerning the date/time the information 11 was used for processing is stored in the data 12 on the memory card 2, and the number of times each of the plurality of application programs has been used for processing the information 11 is stored in the nonvolatile memory 8; in this case, settings can be made so that the CPU 5 performs control to read out as the first piece of information the information 11 most recently used in the memory card 2 from among the information 11 of the data format that can be processed by the most frequently used application program selected based on the frequency-of-use data stored in the nonvolatile memory 8 and, when reading the second and subsequent pieces of information 11, the information recorded in the same data format is sequentially read out in order of date/time of use. When the user loads the memory card 2 into the receiving compartment 3, the most frequently used application program is activated by selecting it from among the plurality of application programs that match the data format of the information 11 stored on the memory card 2 and, among the information 11 recorded in that data format, the most recently used information 11 is read out as the first piece of information from the memory card 2, and the second and subsequent pieces of information 11 recorded in that data format is processed in order of date/time of use, so that the information can be processed sequentially by using the same application program.

Further, data concerning the date/time the information 11 was used for processing is stored in the data 12 on the memory card 2; in this case, settings can be made so that the CPU 5 performs control to read out the most recently used information 11 as the first piece of information from among the information 11 of the data format most predominantly used for the information 11 recorded on the memory card 2, and, when reading the second and subsequent pieces of information 11, the information 11 recorded in the same data format is sequentially read out in order of date/time of use. When the user loads the memory card 2 into the receiving compartment 3, the most recently used information 11 is read out as the first piece of information from the memory card 2 from among the information 11 of the data format most predominantly used for the information 11 recorded on the memory card 2 and, thereafter, the second and subsequent pieces of information 11 recorded in that data format can be processed sequentially in order of date/time of use.

Further, data concerning the date/time of recording of the information 11 is stored in the data 12 on the memory card 2; in this case, settings can be made so that the CPU 5 performs control to search the kinds of the data formats of the information 11 recorded on the memory card 2, select a particular data format at random from among the kinds of the data formats, and read out the most recently recorded information 11 as the first piece of information from among the information 11 of the selected data format and, when reading the second and subsequent pieces of information 11, the information 11 recorded in the same data format is sequentially read out in order of date/time of recording. When the user loads the memory card 2 into the receiving compartment 3, the most recently recorded information 11 is read out as the first piece of information from the memory card 2 from among the information 11 of the data format selected at random from among the data formats of the information 11 recorded on the memory card 2 and, thereafter, the second and subsequent pieces of information 11 recorded in that data format can be processed sequentially in order of date/time of recording.

Further, data concerning the date/time the information 11 was used for processing is stored in the data 12 on the memory card 2; in this case, settings can be made so that the CPU 5 performs control to search the kinds of the data formats of the information 11 recorded on the memory card 2, select a particular data format at random from among the kinds of the data formats, and read out the most recently used information 11 as the first piece of information from among the information 11 of the selected data format and, when reading the second and subsequent pieces of information 11, the information 11 recorded in the same data format is sequentially read out in order of date/time of use. When the user loads the memory card 2 into the receiving compartment 3, the most recently used information 11 is read out as the first piece of information from the memory card 2 from among the information 11 of the data format selected at random from among the data formats of the information 11 recorded on the memory card 2 and, thereafter, the second and subsequent pieces of information 11 recorded in that data format can be processed sequentially in order of date/time of use.

In another embodiment of the present invention, when auto playback is not performed, the CPU 5 can be made to act as a candidate presenting means which, when the memory card 2 is loaded into the receiving compartment 3, searches the kinds of the data formats of the information 11 recorded on the loaded memory card 2, selects from among the plurality of application programs the application programs that can process the information 11 of the data formats thus searched, and presents the selected application programs as candidates. The user operates the keyboard 10 as an operation input means to select one of the candidates displayed on the display device 9. The CPU 5 can also be made to act as a control means which, in response to the input operation performed on the keyboard 10, activates the application program selected from among the candidates and performs control so that the information 11 recorded on the memory card 2 is sequentially read out in accordance with the predetermined ordering criterion from among the information 11 of the data format that can be processed by the activated application program. The user can select one of the candidates by operating the keyboard 10. Thereupon, the CPU 5 activates the application program selected by the user from among the candidates, and performs control so that the information recorded on the recording medium is sequentially read out in accordance with the predetermined ordering criterion from among the information 11 of the data format that can be processed by that application program; this facilitates the activation of the application program suitable for reading the information 11 from the memory card 2.

FIG. 4 shows, as a still another embodiment of the present invention, an information browse screen 30 for rearranging the information 11 recorded on the memory card 2 and a sort screen 31 and a setup screen 32 which are displayed when “SORT” and “SETUP”, respectively, are selected. In this embodiment, at least one of the auto playback functions explained in the earlier described embodiment is carried out. In this embodiment, a trash bin 33 is provided on the information browse screen 30 so that information selected for deletion from the list can be removed from the list of auto playback, etc. without actually erasing it. On the setup screen 32, the condition for actually erasing the information 11 placed in the trash bin 33 is set up. The condition can be selected from two choices, “UPON CARD EJECTION” and “AFTER A PRESET NUMBER OF DAYS”. The number of days can be set as desired by the user.

In each of the embodiments described above, the memory card 2 is used as the recording medium. Since the memory card 2 is recordable, the playback log is recorded as the data 12 and is used when performing auto playback. For other recording media such as CDs and DVDs that are loaded into the deck 13 for playback and that are only readable at least with that deck 13, log information can be stored in the nonvolatile memory 8 or the like in the automotive information processing apparatus 1 in association with ID information identifying each recording medium, and can be used to perform auto playback in the same manner as in the above-described embodiments.

FIG. 5 shows, as a yet another embodiment of the present invention, a specify screen 40 when more than one receiving compartment 3 for the memory card 2 shown in FIG. 1 is provided and when the application program for processing the information 11 can be specified in advance for each receiving compartment 3. On the specify screen 40, application programs are specified, for example, for two receiving compartments 3 designated here as slot A and slot B, respectively. When “SETUP” is selected from the specify screen 40, a setup screen 41 is displayed to enable the user to set the kind of information for each slot. “MUSIC”, “IMAGE”, “DATA”, or their combined type “MULTI” can be selected as the kind of information. If a plurality of application programs can be used for one kind of information, the application program to be used can be specified in like manner. Disk consolidation can also be set that enables the memory cards 2 simultaneously loaded in the plurality of receiving compartments 3 to operate as if they are a single recording medium. When the user selects the receiving compartment 3 into which the memory card 2 is to be loaded, the application program for processing the recorded information 11 is automatically specified, thus simplifying the process of specifying the application program.

The present invention is not limited to the automotive information processing apparatus 1, but can also be implemented as part of an operating system or as one application program in a conventional personal computer or the like. When applied to the automotive information processing apparatus 1, the invention offers the effect of saving the vehicle driver, etc. the trouble of operating the apparatus, and when applied to a personal computer or the like, the invention offers the effect of being able to process various kinds of information in an easy to understand manner.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An information processing apparatus in which a plurality of information processing programs can be operated and a recording format of information to be processed by program operation is predetermined for each of the information processing programs, the apparatus comprising:
medium loading means for removably receiving an information recording medium capable of recording a plurality of pieces of information, the medium loading means being adapted to be able to read out the information recorded on the information recording medium when the information recording medium is loaded therein;
control means for performing control so that, upon loading of the information recording medium to the medium loading means, a first piece of information recorded on the information recording medium is read out in accordance with a predetermined ordering criterion, an information processing program that matches the recording format of the first piece of information is selectively activated to process the first piece of information and, when reading out second and subsequent pieces of information from the information recording medium, the information recorded in the recording format that can be processed by the information processing program is sequentially read out in accordance with the ordering criterion; and
storage means which stores data for reading out the information from the information recording medium in accordance with the ordering criterion.

2. The information processing apparatus of claim 1, wherein data concerning date/time of recording of the information is stored in the storage means, and
the control means performs control so that the information most recently recorded on the information recording medium is read out as the first piece of information by using the date/time of information recording on the information recording medium as the ordering criterion, and the control means activates the information processing program that matches the recording format of the information.

3. The information processing apparatus of claim 1, wherein data concerning date/time the information was used for processing is stored in the storage means, and
the control means performs control so that the information most recently used in the information recording medium is read out as the first piece of information by using as the ordering criterion the date/time the information recorded on the information recording medium was last used, and the control means activates the information processing program that matches the recording format of the information.

4. The information processing apparatus of claim 1, wherein data concerning the number of times the information has been used for processing is stored in the storage means, and
the control means performs control so that the information most frequently used in the information recording medium is read out as the first piece of information by using as the ordering criterion the number of times the information recorded on the information recording medium has been used, and the control means activates the information processing program that matches the recording format of the information.

5. The information processing apparatus of claim 1, wherein data concerning the number of times the information has been used for processing is stored in the storage means, and
the control means performs control so that the total number of times the information recorded on the information recording medium has been used is calculated for each recording format and, by using the total number of times as the ordering criterion, the information selected in accordance with a predetermined criterion is read out as the first piece of information from among the information of the most frequently used recording format in the information recording medium, and the control means activates the information processing program that matches the recording format of the information.

6. The information processing apparatus of claim 5, wherein the predetermined criterion is the date/time of recording.

7. The information processing apparatus of claim 1, wherein information of a particular recording format that can be processed by any one of a plurality of information processing programs is recorded on the information recording medium,
the information processing apparatus further includes other storage means for storing the number of times each of the information processing programs that can process the information of the particular recording format has been used for processing the information, and
the control means performs control so that, when the information read out as the first piece of information from the information recording medium is the information of the particular recording format that can be processed by any one of the plurality of information processing programs, the most frequently used information processing program is activated based on the number of times stored in the other storage means.

8. The information processing apparatus of claim 1, wherein data concerning date/time of recording of the information and, of the plurality of information processing programs, the information processing program last used for the processing of the information, are stored in the storage means, and
the control means performs control so that the information most recently recorded on the information recording medium is read out as the first piece of information from among the information of the recording format that can be processed by the information processing program recorded in the storage means and, when reading out the second and subsequent pieces of information, the information recorded in that recording format is sequentially read out in order of date/time of recording.

9. The information processing apparatus of claim 1, wherein data concerning date/time the information was used for processing and, of the plurality of information processing programs, the information processing program last used for the processing of the information, are stored in the storage means, and
the control means performs control so that the information most recently used in the information recording medium is read out as the first piece of information from among the information of the recording format that can be processed by the information processing program stored in the storage means and, when reading out the second and subsequent pieces of information, the information recorded in that recording format is sequentially read out in order of date/time of use.

10. The information processing apparatus of claim 1, wherein data concerning date/time of recording of the information and the number of times each of the plurality of information processing programs has been used for the processing of the information are stored in the storage means, and
the control means performs control so that the information most recently recorded on the information recording medium is read out as the first piece of information from among the information of the recording format that can be processed by the most frequently used information processing program stored in the storage means and, when reading out the second and subsequent pieces of information, the information recorded in that recording format is sequentially read out in order of date/time of recording.

11. The information processing apparatus of claim 1, wherein data concerning date/time the information was used for processing and the number of times each of the plurality of information processing programs has been used for the processing of the information are stored in the storage means, and
the control means performs control so that the information most recently used in the information recording medium is read out as the first piece of information from among the information of the recording format that can be processed by the most frequently used information processing program stored in the storage means and, when reading out the second and subsequent pieces of information, the information recorded in that recording format is sequentially read out in order of date/time of use.

12. The information processing apparatus of claim 1, wherein data concerning date/time the information was used for processing is stored in the storage means, and
the control means performs control so that, among the information of the recording format most predominantly used for the information recorded on the information recording medium, the information most recently used in the information recording medium is read out as the first piece of information and, when reading out the second and subsequent pieces of information, the information recorded in that recording format is sequentially read out in order of date/time of use.

13. The information processing apparatus of claim 1, wherein data concerning date/time of recording of the information is stored in the storage means, and
the control means performs control to search the kinds of the recording formats of the information recorded on the information recording medium, select a particular recording format at random from among the kinds of the recording formats, and read out the most recently recorded information as the first piece of information from among the information recorded in that recording format, and when reading out the second and subsequent pieces of information, the information recorded in that recording format is sequentially read out in order of date/time of recording.

14. The information processing apparatus of claim 1, wherein data concerning date/time the information was used for processing is stored in the storage means, and
the control means performs control to search the kinds of the recording formats of the information recorded on the information recording medium, select a particular recording format at random from among the kinds of the recording formats, and read out the most recently used information as the first piece of information from among the information recorded in that recording format, and when reading out the second and subsequent pieces of information, the information recorded in that recording format is sequentially read out in order of date/time of use.

15. An information processing apparatus in which a plurality of information processing programs can be operated and a recording format of information to be processed by program operation is predetermined for each of the information processing programs, the apparatus comprising:
medium loading means for removably receiving an information recording medium capable of recording a plurality of pieces of information, the medium loading means being adapted to be able to read out the information recorded on the information recording medium when the information recording medium is loaded therein;
candidate presenting means which, upon detecting the loading of the information recording medium to the medium loading means, searches the kinds of the recording formats of the information recorded on the loaded information recording medium and, of the plurality of information processing programs, presents as candidates the information processing programs that can process the information of the thus searched recording formats;
operation input means for accepting an input operation for selecting one of the candidates presented by the candidate presenting means; and
control means for activating the information processing program selected from among the candidates in response to the input operation performed on the operation input means, and for performing control so that the information recorded on the information recording medium is sequentially read out in accordance with a predetermined ordering criterion from among the information of the recording format to be processed by the selected information processing program.

16. The information processing apparatus of claim 1, wherein the information recording medium is a memory card, and
the storage means is provided within the information recording medium.

17. The information processing apparatus of claim 16, wherein the medium loading means is provided with more than one receiving compartment for receiving the information recording medium, and
an information processing program for processing the information can be prespecified for each receiving compartment.

18. A program for causing a computer to function as the information processing apparatus of claim 1.

19. A computer readable recording medium on which a program is recorded which causes a computer to implement the steps of:
in response to loading an information recording medium capable of recording a plurality of pieces of information to medium loading means for removably receiving the information recording medium, retrieving a plurality of pieces of information recorded in the information recording medium and data for reading out the plurality of pieces of information in accordance with a predetermined ordering criterion stored in storage means;
reading out the data from the storage means;
reading out a first piece of information recorded on the information recording medium, in accordance with the predetermined ordering criterion;
selectively activating an information processing program that matches a recording format of the first piece of information, out of a plurality of information processing programs, and processing the first piece of information; and
reading out second and subsequent pieces of information recorded in a recording format that can be processed by the information processing program, in accordance with the ordering criterion, and processing the second and subsequent pieces of information.

20. A computer readable recording medium on which a program is recorded which causes a computer to implement the steps of:
in response to loading an information recording medium capable of recording a plurality of pieces of information to medium loading means for removably receiving the information recording medium, retrieving a recording format of information recorded in the information recording medium loaded to the medium loading means;
presenting as candidates information processing programs that can process information of thus retrieved recording format, out of a plurality of information processing programs;
in response to an operation of selection from among the presented candidates by a user, activating an information processing program selected; and
sequentially reading out the information recorded on the information recording medium in accordance with a predetermined ordering criterion from among the information of the recording format to be processed by the selected information processing program.
